(19) United States
(12) Patent Application Publication
(10) Pub. No.: US 2019/0392311 A1
(43) Pub. Date: Dec. 26, 2019

(54) METHOD FOR QUANTIZING A HISTOGRAM OF AN IMAGE, METHOD FOR TRAINING A NEURAL NETWORK AND NEURAL NETWORK TRAINING SYSTEM

(71) Applicant: Deep Force Ltd., Taipei City (TW)

(72) Inventors: Liu Liu, Taipei City (TW); May-Chen Martin-Kuo, Taipei City (TW)

(21) Appl. No.: 16/435,626

(22) Filed: Jun. 10, 2019

Related U.S. Application Data
(60) Provisional application No. 62/687,830, filed on Jun. 21, 2018.

(51) Int. Cl. G06N 3/08; G06N 3/04; G06F 17/18

(52) U.S. Cl. CPC G06N 3/08; G06F 17/18; G06N 3/0472

(57) ABSTRACT

A method for quantizing an image includes estimating a probability distribution by number of pixels versus gray level intensity from an image to create a histogram of the image; calculating a cumulative distribution function (CDF) of the histogram using the probability distribution; segmenting the gray level intensity into segments based on the cumulative distribution function; and quantizing the histogram based on the segments. Herein, the segments have identical number of pixel.

### CROSS-REFERENCE TO RELATED APPLICATION

This non-provisional application claims priority under 35 U.S.C. § 119(e) to U.S. Provisional Patent Application No. 62/687,830, filed on Jun. 21, 2018, the entire contents of which are hereby incorporated by reference.

### BACKGROUND

### Technical Field

The present invention relates to artificial intelligence (AI) and, in particular, relates to a method for quantizing a histogram of an image, a method for training a neural network and a neural network training system.

### Related Art

Most artificial intelligence (AI) algorithms need huge amounts of data and computing resource to accomplish tasks. For this reason, they rely on cloud servers to perform their computations, and aren't capable of accomplishing much at edge devices where the applications that use them to perform.

However, more intelligence is continually moving to edge devices, such as desktop PCs, tablets, smart phones and internet of things (IoT) devices. Edge device is becoming the pervasive artificial intelligence platform. It involves deploying and running the trained neural network model on edge devices. In order to achieve the goal, neural network training needs to be more efficient if it performs certain preprocessing steps on the network inputs and targets. Training neural networks is a hard and time-consuming task, and it requires horse power machines to finish a reasonable training phase in a timely manner.

By normalizing all of the inputs to a standard scale, it is allowing the neural network to more quickly learn the optimal parameters for each input node. When the inputs to neural networks are on widely different scales, normalization is used to get the same range of values for each of the input features. For instance, a first input value varies from 0 to 1 while the second input value varies from 0 to 0.01. Since the neural network is tasked with learning how to combine these inputs through a series of linear combinations and nonlinear activations, the parameters associated with each input will also exist on different scales.

However, conventional data processing method does not really normalize the scale into the ideal case. The rate for dimension of features is not really balanced and would affect the neural network performance.

### SUMMARY

In an embodiment, a method for quantizing an image includes: estimating a probability distribution by number of pixels versus gray level intensity from an image to create a histogram of the image; calculating a cumulative distribution function (CDF) of the histogram using the probability distribution; segmenting the gray level intensity into segments based on the cumulative distribution function; and quantizing the histogram based on the segments. Herein, the segments have identical number of pixel.

In an embodiment, a method for training a neural network includes creating a histogram of data; calculating a cumulative distribution function of the histogram; determining a plurality of variable widths through the cumulative distribution function; assigning the variable widths to a plurality of bins in the histogram; and performing a training of a neural network based on the assigned histogram.

In an embodiment, a non-transitory computer-readable storage medium includes instructions that, when executed by at least one processor of a computing system, cause the computing system to perform: creating a histogram of data; calculating a cumulative distribution function of the histogram; determining a plurality of variable widths through the cumulative distribution function; assigning the variable widths to a plurality of bins in the histogram; and performing a training of a neural network based on the assigned histogram.

In an embodiment, a neural network training system includes an input unit, a pre-processing unit, and a neural network. The input unit is configured to receive an input data. The pre-processing unit is coupled to the input unit, and is configured to create and equalize a histogram of the input data and align the equalized histogram with variable widths of bins to generate a processed input data. The neural network is coupled to the pre-processing unit and is configured to receive the processed input data and perform a neural network training based on the processed input data.

As above, the embodiments utilize normalizing the distribution of number of pixels to trend to equalization, thereby greatly improving the data values on both sides of the histogram. In some embodiments, the object features of the data are aligned to almost uniform distribution based on the histogram generated of the data in training process. During prediction, a simplified approach transfers the data to similar distributions as in training set, which leads to faster converge and better prediction accuracy.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below illustration only, and thus are not limitative of the present invention, and wherein:

FIG. 1 is a schematic view of a neural network training system according to an embodiment.

FIG. 2 is a flow chart of a method for training a neural network according to an embodiment.

FIG. 3 is a flow chart of a method for quantizing the histogram according to an embodiment.

FIG. 4 illustrates an example of the data.

FIG. 5 illustrates an example of a histogram of the data in FIG. 4.

FIG. 6 illustrates another example of the data.

FIG. 7 illustrates an example of a histogram of the data in FIG. 6 before equalizing.

FIG. 8 illustrates an example of a histogram of the data in FIG. 6 after equalizing.

FIG. 9 illustrates the data presented by the histogram in FIG. 8.

FIG. 10 illustrates an example of a histogram with bins having fixed width.

FIG. 11 illustrates an example of a histogram with bins having variable widths.

### DETAILED DESCRIPTION

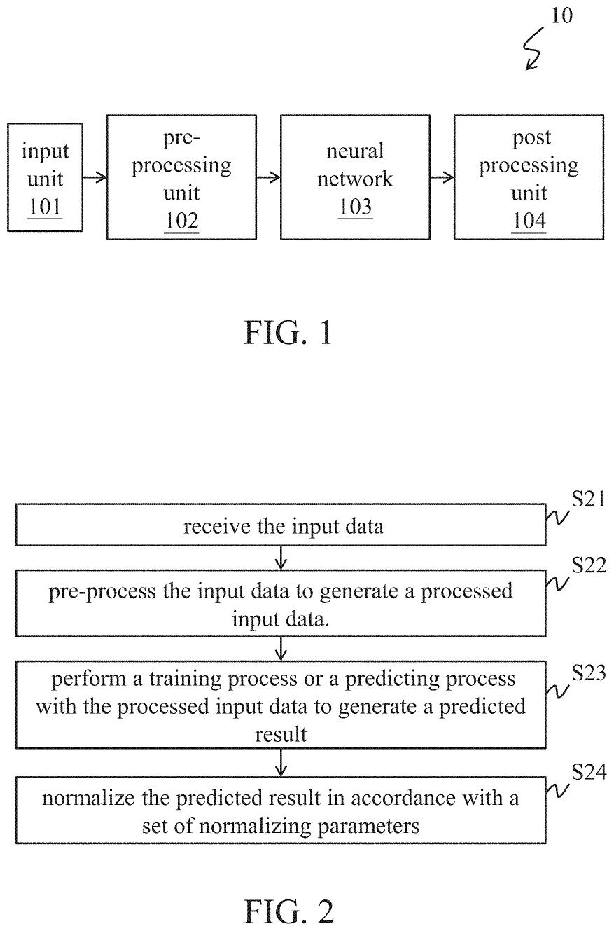

FIG. 1 is a schematic view of a neural network training system according to an embodiment. Referring to FIG. 1, the neural network training system 10 is adapted to execute training or predicting on training items with an input data to generate a predicted result. The neural network training system 10 includes an input unit 101, a pre-processing unit 102, and a neural network 103. The pre-processing unit 102 is coupled between the input unit 101 and the neural network 103.

Refer to FIG. 1 and FIG. 2. The input unit 101 is configured to receive the input data (Step S21). The pre-processing unit 102 is configured to pre-process the input data to generate a processed input data (Step S22).

In some embodiments, the steps of pre-processing the input data include strengthening at least an object feature within the input data.

In some embodiments, the steps of strengthening the object feature within the input data include quantizing the input data in a variable bin width manner (also called as quantizing process in the followings). The quantizing process is the process of mapping initial values (e.g. the input data) from a large set (often a continuous set) to output strengthened values (e.g. the processed input data) in a (countable) smaller set. In some embodiments, the quantizing process can include, but not limited to, rounding process and/or truncation process. In some embodiments, if the processed input data is represented by a signal in digital form, the quantizing process ordinarily involves the rounding process.

For example, if the input data is an image or features that have been extracted from images, the steps of strengthening at least an object feature within the input data can include performing an image processing. In some embodiments, the image processing is configured to re-encode using fewer bits than the original representation of the input data. In some embodiments, the image processing can be, but not limited to, data compression, source coding, bit-rate reduction, or any combination thereof. In some embodiments, the data compression additionally employs lossy compression techniques that reduce aspects of the source data that are (more or less) irrelevant to the human visual perception by exploiting perceptual features of human vision. For example, small differences in color are more difficult to perceive than are changes in brightness. Herein, the lossy compression techniques can be, for example, the quantizing process for the input data. In some embodiments, the data compression can be executed by using compression algorithms which can average a color across these similar areas of the input data to reduce space.

In some embodiments, the steps of pre-processing the input data further include modifies the current scales of the feature parameters based on the input data for the training item. In other words, the neural network training system 10 can works in one of a training mode and a predicting mode. In the training mode, the input data is training data, and the pre-processing unit 102 repeatedly updates the values of the feature parameters based on the training data. Thus, in the predicting mode, the pre-processing unit 102 can align the input data to the training item according to the current scales of the feature parameters.

The neural network 103 is configured to receive the processed input data from the pre-processing unit 102, and to perform a training process or a predicting process with the processed input data (Step S23). In some embodiments, the neural network 103 can be, but not limited to, a feedforward deep neural network or a recurrent neural network. The feedforward deep neural network is, for example, a convolutional neural network. The recurrent neural network is, for example, a long short term (LSTM) neural network. In some embodiments, the input data can be a digital data.

In the training mode, the neural network 103 perform the training process with the processed input data (i.e. the training data processed by the pre-processing unit 102) to modify the respective weight of each connection in the group of connections. That is, the neural network 103 is trained based on the processed input data to establish a predictive model. The architecture of the predictive model is dependent on the kinds of inputs that the neural network 103 is configured to process and the kinds of outputs that the neural network 103 is configured to generate. In the predicting mode, the neural network 103 perform the predicting process with the processed input data on the training items by using the predictive model having the group of connections with the respective weights.

After the predicting process, the neural network 103 outputs a predicted result. In some embodiments, the predicted result can be, but not limited to, a predicted object recognition output. The predicted object recognition output is, for example, score or classification.

For example, if the input data is an image or features that have been extracted from images, the predicted result generated by the neural network 110 may be one or more image scores for a set of object category. Herein, each image score represents an estimated likelihood that the image contains an image block of an object belonging to the corresponding object category.

As another example, if the input data is a sequence of text in one language, the predicted result generated by the neural network 110 may be at least a translation score for a set of piece of text in another language. Herein, each translation score represents an estimated likelihood that the corresponding piece of text in the other language is a proper translation of the sequence of text into the other language.

As yet another example, if the input data is a sequence representing a spoken utterance, the predicted result generated by the neural network 103 may be at least an utterance score for a set of pieces of text. Herein, each utterance score represents an estimated likelihood that the corresponding piece of text is the correct transcript for the spoken utterance.

In some embodiments, during the training process or the predicting process, the neural network 103 further includes perform a quantizing process. That is, the neural network 103 quantizes the data is inputted in one of the group of connections in the variable bin width manner. After the quantizing, the neural network 103 continues performing the training process or the predicting process based on the quantized data.

In some embodiments, if the un-normalized outputs are desirable after the training process or the predicting process, the neural network 103 further includes un-normalizing an initial result to the predicted result by applying the normalization parameters. In some embodiments, the neural network 103 is trained or predicted using the processed input data to generate one or more normalized outputs (i.e. the initial result) that are mappable. Then, the neural network 103 further maps the normalized outputs mappable to one or more un-normalized outputs (i.e. the predicted result) in accordance with a set of normalization parameters.

In some embodiments, the neural network training system 10 further includes a post processing unit 104. The neural network 103 is coupled between the pre-processing unit 102 and the post processing unit 104.

The post processing unit 104 is configured to normalize the predicted result in accordance with a set of normalizing parameters to generate a normalized output (Step S24).

In some embodiment, the neural network 103 includes one or more input layers. The input layers can replace the aforementioned pre-processing unit 102.

In some embodiment, the neural network 103 includes one or more output layers. The output layers can replace the aforementioned post processing unit 104.

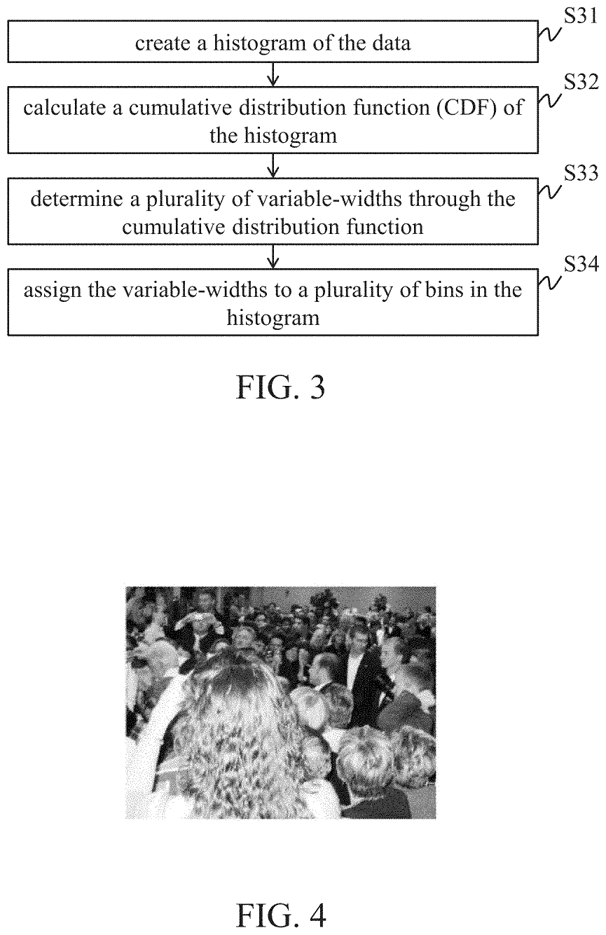

In some embodiments, referring to FIG. 3, the aforementioned quantizing process includes creating a histogram of the data (Step S31), calculating a cumulative distribution function (CDF) of the histogram (Step S32), determining a plurality of variable widths through the cumulative distribution function (Step S33), and assigning the variable widths to a plurality of bins in the histogram (Step S34).

For example, if the input data is an image or features that have been extracted from images, the image is a discrete space composed of small surface elements called pixel. Each of the surface elements contains a value coding the intensity level at each position or a set of value coding the intensity level at each position.

A probability distribution by number of pixels versus gray level intensity from an image is estimated to create a histogram of the image, and a cumulative distribution function (CDF) of the histogram is calculated using the probability distribution.

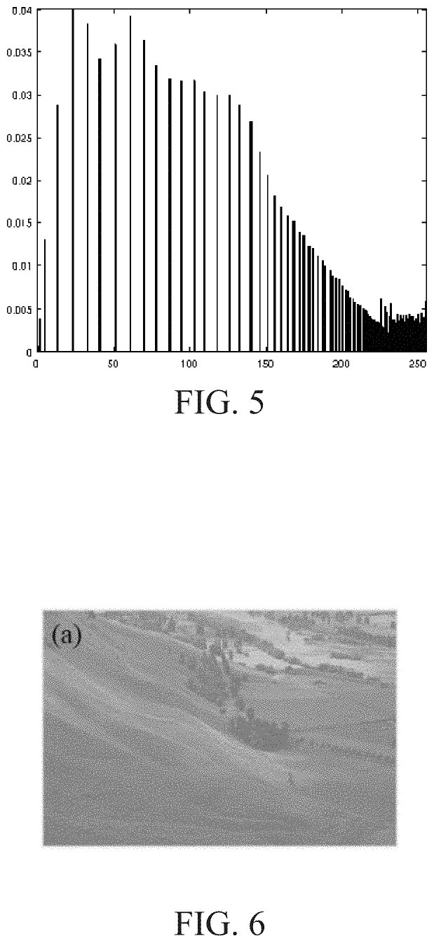

A histogram of a digital image is a distribution of its discrete intensity levels in the range [0, L-1]. The distribution is a discrete function h associating to each intensity level and the number of pixel with this intensity. If the data is the digital image shown in FIG. 4, the created histogram is as shown in FIG. 5. Referring to the FIG. 5, the x-axis is the intensity value from 0 to 255. The y-axis varies depending on the number of the pixels in the image and how their intensities are distributed. In the histogram, the y-axis on the graph represents the number of pixel, while the x-axis represents the gray level intensity. For example, the feature is gray level that is a range of shades of gray without apparent color. An 8-bit gray image with n=8 bits will have possible intensity values going from 0 representing black to L-1=255 representing white.

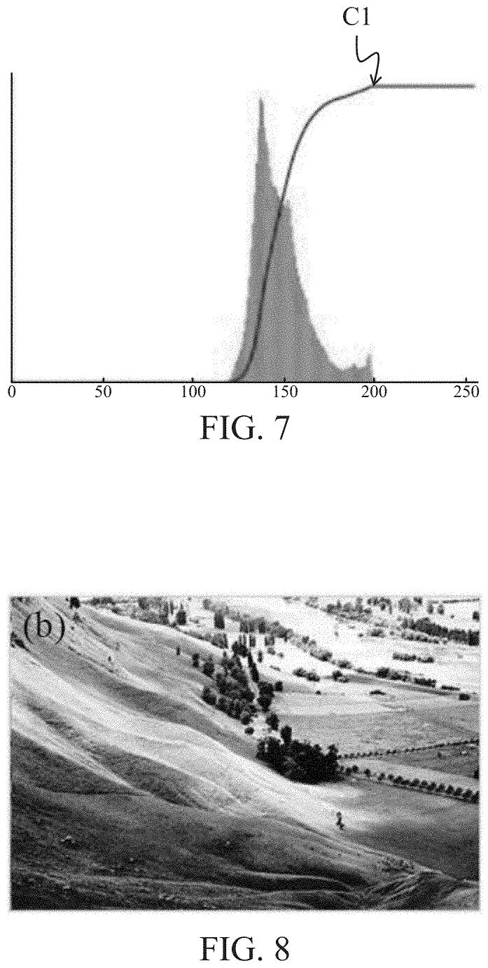

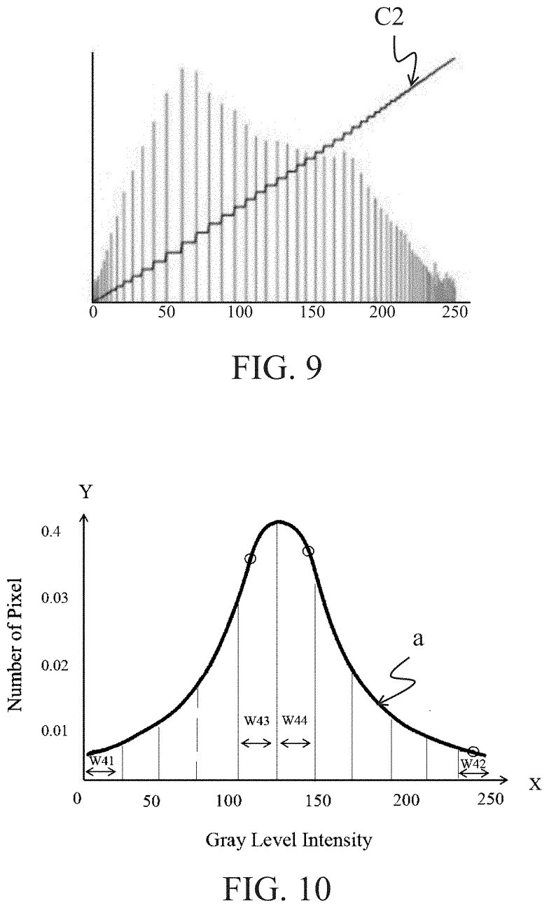

In order to adjust the contrast of an image, the image is processed by spreading the intensity distribution of the histogram. The histogram distribution is the distributed pixels in uniformly over the whole intensity range to give a linear trend to the cumulative probability function (CDF) associated to the image. That is, the histogram spreads out intensity values along the total range of intensity values (also call as histogram equalization) in order to achieve higher contrast. For example, if the data is the digital image shown in FIG. 6, the created histogram and the cumulative probability function C1 associated to this image are as shown in FIG. 7. The equalization of the created histogram is applied to generate a spread histogram and it's the cumulative probability function C2 (as shown in FIG. 8). Herein, the image associated to the cumulative probability function C2 is presented in FIG. 9.

Then, the gray level intensity is segmented into segments based on the cumulative distribution function. Here, each segment comprising identical number of pixel

For example, the default histogram has bins with a fixed width (for example, W41, W42, W43 and W44), as shown in FIG. 10. In FIG. 10, the curve (a) presents a trend of the default histogram. Herein, the data value representing each bin is calculated by averaging the data values belonging to the same bin. The default histogram indicates that the data are not uniformly distributed; the left and right endpoints of the bins are near 0. It is known that the count in the leftmost bin (W41) is much lower than the center bin (W43). Similarly, the count in the rightmost bin (W42) is much lower than the count of a center bin (W44).

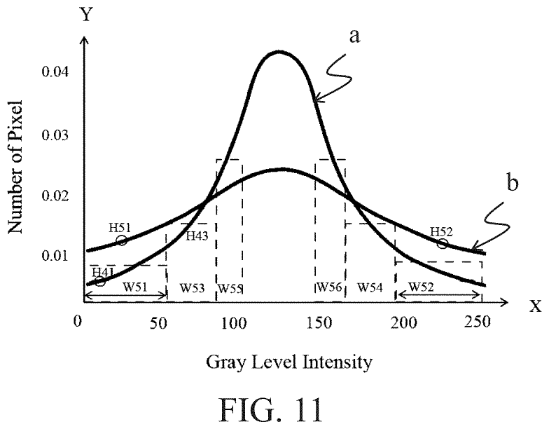

The created histogram is re-assigned a bin amount to the sorted gray level intensity from 0 to 255, and then applied area calculation method to obtain the corresponding data values of each bin with constant area instead of fixed width from input data, as shown in FIG. 11. In FIG. 11, the curve (b) presents a trend of the assigned histogram. The area of each segment can be calculated by multiplying the average number of pixel inside the segment by the segment width. Each bin includes substantially the same number of pixels that define its width as the numbers of pixel defining the widths of the other bins. The height of a bin indicates the volume of pixel included in the bin, and/or the volume of records represented in the bin. For example, first bin W51 has a width defined by 50 gray level intensity, and an average height H41 defined by 0.08 probability distribution (i.e., a total volume of 4-pixel units). In contrast, second bin W53 also has a width defined by 25 gray level intensity but has an average height H53 defined by 0.16 probability distribution (a total volume of 4-pixel units). It is to be understood that the term “equal-volume” means that each bin includes substantially the same number of pixels or pixel units defining the width of the bar. The term “equal-volume” does not mean that the volumes are strictly equal (e.g., they may vary by a small number of pixels, such as a variation within 5%), although they may be strictly equal. A data value increasing in height from both ends toward the center of the chart induces a data value decreasing in weight from both ends toward the center. In some embodiments, the number of the bins is larger than 10 bins.

In one case, the area under the curve (a) is filled with a bunch of little rectangles, and then it keeps up the area of all the rectangles are identical. Here, the width of each rectangle is made as the height of the curve (a) at the midpoint of the rectangles (i.e. the average data value belonging to the same bin), and all rectangles have the same area. After estimating, the bins on two sides are more closed to the central point of the histogram. Therefore, the distribution of the histogram is more smoothly varying. Actually, the width (W51) of the leftmost bin is larger than the width (W53, W55) of the bins closing to the center of the histogram and the average pixel value (H51) of the leftmost bin in the histogram with the variable widths is dramatically enhanced than the average pixel value (H41) of the leftmost bin in the histogram with the fixed width. It is obvious that the data value of each bin on both sides of the histogram is less than the data value of bin on a center of the histogram.

In some embodiments, the variable width is determined based on a predetermined percentage of the input data. In some embodiments, the number of pixel of each segment (bin) gives less than 10 percent of the image. Preferably, the number of pixel of each segment (bin) gives less than 5 percent of the image for a smooth linear curve.

In some embodiments, the data is a compressed image, and a compressed image may have pixels with a size of n bits (e.g., 8-bit pixels) that each stores m (e.g., four, two) compressed data value having a size of n/2 or less bits (e.g., 4-bit, 2-bit data values). In this case, the number of each segment is determined between n (i.e. total data bits of the image) and 2^{n/2}. Herein, n is positive integer.

In some embodiments, the pre-processing unit 102, and a neural network 103 (and the post processing unit 104) can be embodied by one or more processors.

In another embodiment, the method described in this specification can be embodied in a non-transitory computer-readable storage medium. The non-transitory computer-readable storage medium includes instructions executable by one or more processors which, upon such execution, causes the one or more processors to perform the aforementioned operation. The non-transitory computer-readable storage medium may also be another form of computer-readable medium, such as a floppy disk device, a hard disk device, an optical disk device, or a tape device, a flash memory or other similar solid-state memory device, or an array of devices, including devices in a storage area network or other configurations.

As above, the embodiments utilize normalizing the distribution of number of pixels to trend to equalization, thereby greatly improving the data values on both sides of the histogram. In some embodiments, the object features of the data are aligned to almost uniform distribution based on the histogram generated of the data in training process. During prediction, a simplified approach transfers the data to similar distributions as in training set, which leads to faster converge and better prediction accuracy. In some embodiments, each input image is adaptively rescaled during training, and the neural network can be effectively trained even if scales of target inputs are the same during the training. In particular, it is more improved when to train the neural network to perform loss function task that converges to the right direction. In some embodiments, adaptively rescaling inputs during training allows the natural magnitude of each input to be disentangled for improving prediction accuracy since prediction has similar statistic attributes as training set, which improves the accuracy of prediction. This is particularly useful when the inputs are in different units, e.g., when the neural network is simultaneously predicting many signals of an agent with multi-modal sensors.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for quantizing an image, comprising:
estimating a probability distribution by number of pixels versus gray level intensity from an image to create a histogram of the image;
calculating a cumulative distribution function (CDF) of the histogram using the probability distribution;
segmenting the gray level intensity into segments based on the cumulative distribution function, wherein the segments have identical number of pixel; and
quantizing the histogram based on the segments.

2. The method for quantizing the histogram of claim 1, wherein the number of each of the segments is larger than 10.

3. The method for quantizing the histogram of claim 1, wherein data value of the image is n bits and the number of the segments is determined between the n and 2^{n/2}.

4. The method for quantizing the histogram of claim 1, wherein width of segments on both sides of the histogram are larger than width of segment on a center of the histogram.

5. The method for quantizing the histogram of claim 1, wherein data value of each of the segments is calculated by averaging data values of the pixels belonging to the same segment.

6. The method for quantizing the histogram of claim 1, wherein the number of the pixels of each of the segments is less than 10 percent of the image.

7. The method for quantizing the histogram of claim 6, wherein the number of the pixels of each of the segments is less than 5 percent of the image.

8. A method for training a neural network, comprising:
creating a histogram of data;
calculating a cumulative distribution function of the histogram;
determining a plurality of variable widths through the cumulative distribution function;
assigning the variable widths to a plurality of bins in the histogram; and
performing a training of a neural network based on the assigned histogram.

9. The method for training the neural network of claim 8, wherein the input data is an image and the step of creating the histogram of the input data comprises calculating the histogram by number of pixels versus gray level intensity.

10. The method for training the neural network of claim 8, wherein the number of the bins is larger than 10.

11. The method for training the neural network of claim 8, wherein the input data is an image, data value of the image is n bits and the number of the bins is determined between the n and 2^{n/2}.

12. The method for training a neural network of claim 8, wherein the step of determining the variable widths through the cumulative distribution function is executed based on a predetermined percentage of the input data.

13. The method for training a neural network of claim 12, wherein the input data is an image and the predetermined percentage of the input data is less than 10 percent of the number of the pixels of the image.

14. The method for training a neural network of claim 12, wherein the predetermined percentage of the input data is less than 5 percent of the number of the pixels of the image.

15. The method for training a neural network of claim 12, wherein width of each of two bins on two sides of the assigned histogram is larger than width of a bin on a center of the assigned histogram.

16. The method for training a neural network of claim 12, wherein data value of each of bins on two sides of the assigned histogram is less than data value of a bin on a center of the assigned histogram.

17. The method for training a neural network of claim 8, wherein data value representing each of the bins is calculated by averaging data values belonging to the same bin.

18. The method for training a neural network of claim 8, wherein the step of performing the training of the neural network using the assigned histogram comprises: modifying a respective weight of each connection in the group of connections of the neural network to cause the neural network to produce a predicted object recognition output.

19. A non-transitory computer-readable storage medium including instructions that, when executed by at least one processor of a computing system, cause the computing system to perform:
creating a histogram of data;
calculating a cumulative distribution function of the histogram;
determining a plurality of variable widths through the cumulative distribution function;
assigning the variable widths to each bin in the histogram; and
performing a training of a neural network based on the assigned histogram.

20. A neural network training system, comprising:
an input unit configured to receive an input data;
a pre-processing unit, coupled to the input unit, configured to create a histogram of the input data and quantizing the histogram with variable widths of bins to generate a processed input data; and
a neural network, coupled to the pre-processing unit, configured to receive the processed input data and perform a neural network training based on the processed input data.

21. The neural network training system of claim 20, wherein the number of the bins is larger than 10 bins.

22. The neural network training system of claim 20, wherein the widths of bins on both sides of the histogram are larger than the width of a bin on a center of the histogram.

23. The neural network training system of claim 20, wherein data value of each of the bins is calculated by averaging data values belonging to the same bin.

24. The neural network training system of claim 20, wherein data value of each of bins on both sides of the histogram are less than data value of bin on a center of the histogram.

25. The neural network training system of claim 20, wherein the input data is an image and the histogram of the input data is calculated by number of pixels versus gray level intensity from the image.

26. The neural network training system of claim 25, wherein data value of the image is n bits and the number of the bins is determined between the n and 2^{n/2}.

27. The neural network training system of claim 25, wherein the variable widths are determined based on a predetermined percentage of the input data.

28. The neural network training system of claim 27, wherein the predetermined percentage of the input data is less than 10 percent of the number of the pixels of the image.

29. The neural network training system of claim 28, wherein the predetermined percentage of the input data is less than 5 percent of the number of the pixels of the image.
